(19) United States
(12) Patent Application Publication
(10) Pub. No.: US 2001/0047814 A1
(43) Pub. Date: Dec. 6, 2001

(54) Method and apparatus for sterilizing fresh fruit

(76) Inventors: Uzor U. Nwoko, Fort Worth, TX (US); Michael D. Valenzuela, Casselberry, FL (US); Charles E. Jones, Fort Worth, TX (US)

Correspondence Address: DECKER, JONES, MCMACKIN, MCCLANE, HALL &, BATES, P.C., BURNETT PLAZA, 801 CHERRY STREET, SUITE 2000, FORT WORTH, TX, 76102-6836, US

(21) Appl. No.: 09/867,044

(22) Filed: May 29, 2001

Related U.S. Application Data
(60) Provisional application No. 60/208,117, filed on May 31, 2000.

(51) Int. Cl. B08B 3/04

(52) U.S. Cl. 134/25.3; 134/32; 134/126; 134/134; 134/104.1

(57) ABSTRACT

A wash tank has a conveyor belt traversing through a sterilizing wash bath. Fruit is loaded into the wash tank by way of an inclined ramp having a swinging barrier at the end thereof. The conveyor belt has rows of chevron shaped fingers extending generally transversely therefrom. The fingers extend through slots in the ramp to push the fruit through the swinging barrier and into a cage. The conveyor belt and fingers pass through the cage, which cage has a top and sides. The conveyor fingers push the fruit through the cage and the wash bath. The fruit, which tends to float, is kept wholly submerged in the wash bath by the cage. This ensures that the entire skin of the fruit is washed and sterilized. A grate along the sides of the conveyor captures large debris. Hold down plates guide the upper portion of the conveyor belt from a descending portion to a horizontal portion and then to an ascending portion relative to the water bath. There is also a second conveyor located at the outfeed end of the wash tank. Rotating brushes clean the conveyor. The second conveyor is controlled by a photoelectric sensor at the far end thereof. When fruit is present at the far end of the conveyor, the photoelectric sensor and the controller stop the motion of the second conveyor so as to preserve the sterile integrity of the fruit.

This is a continuation-in-part of U.S. application Ser. No. 60/208,117, filed May 31, 2000.

### FIELD OF THE INVENTION

The present invention relates to methods and apparatuses for cleaning and sterilizing fresh fruit for human consumption.

### BACKGROUND OF THE INVENTION

As with many types of foods, fruit is susceptible to spoilage. If the spoilage rate cannot be controlled, then the shelf life of the fruit will be short. In fact, the shelf life may be too short to allow for transportation of the fruit from where the fruit is grown to markets.

One of the factors affecting the spoilage of fruit is bacteria. When the fruit is picked, the skin of the fruit has bacteria on it. The inside of the fruit, or flesh of the fruit, has little or any bacteria. Over time, the fruit ripens and the skin becomes more porous. Bacteria can penetrate the porous skin to the interior flesh. The bacteria feed on the fruit and eventually spoil the fruit.

Fruit spoils in other ways as well. For example, enzymes in and around the seed area can cause overipeness and eventually spoilage.

Of course, there are in the prior art several ways to preserve fruit so as to increase its shelf life. One common way is to can the fruit. Canning involves cooking cut up pieces of fruit. The cooked fruit is then placed into sterilized jars. Canning produces a very long shelf life. Another way to preserve fruit is by freezing. The fruit can be frozen with or without a sugar pack.

Canning and freezing alter the taste and texture of the fruit by dulling the robust flavors and reducing the firmness relative to fresh fruit. The extreme change in temperature is disruptive to the nutrients and cellular structure of the fruit. Many people prefer eating fresh fruit instead of canned or frozen fruit because of the high quality taste and texture.

Because there is a demand for fresh fruit, there is a need to increase the shelf life of fresh fruit.

In our prior practice, we have extended the shelf life of fresh fruit by sterilizing the outside skins of melons. The particular process involved the use of kettles of hot water. The fruit was loaded into the kettle. Because the melons floated to the surface of the water, a perforated basket was then put on top of the fruit and hung on the lip or edge of the kettle. When the lid or cover of the kettle was put on, the basket was pushed down into the water, thereby pushing the fruit down so as to be wholly submerged. Although this process was used to wash and sterilize fruit for commercial sale, the process itself has been kept confidential.

Our prior practice only washed and sterilized batches of fruit. There is a need to wash and sterilize larger quantities of fruit.

### SUMMARY OF THE INVENTION

It is an object of the present invention to provide a method and apparatus for sterilizing fresh fruit without affecting the freshness of the fruit.

It is another object of the present invention to provide a method and apparatus for cleaning conveyor belts that convey the fresh fruit.

The present invention provides a method for sterilizing fresh fruit. The method introduces the fruit into a wash bath. The fruit is conveyed through the bath. While the fruit is being conveyed in the bath, the fruit is maintained in a submerged condition in the bath. The fruit is then removed from the bath.

The present invention is able to wash and sterilize fresh fruit, even though the fresh fruit floats. The present invention does this by maintaining the fruit in a submerged condition while the fruit is being conveyed through a bath. In this manner, large quantities of fruit can be washed and sterilized on a continuous basis.

In accordance with one aspect of the present invention, the fruit includes melons.

In accordance with another aspect of the present invention, the step of conveying the fruit through the bath further includes the step of pushing the fruit with a conveyor belt.

In accordance with another aspect of the present invention, the step of pushing the fruit with a conveyor belt further comprises the steps of locating the conveyor belt beneath the fruit and using extensions from the conveyor belt to contact the fruit.

In accordance with still another aspect of the present invention, the step of maintaining the fruit in a submerged condition further comprises the step of providing a ceiling that is below a level of the bath, with the fruit being conveyed beneath the ceiling.

In accordance with still another aspect of the present invention, the level of the bath is maintained at a constant level.

In accordance with still another aspect of the present invention, the step of maintaining the fruit in a submerged condition in the bath further comprises conveying the fruit through a submerged passageway.

In accordance with still another aspect of the present invention, the fruit is chilled to a temperature that is lower than room temperature before the fruit is introduced into the wash bath.

In accordance with still another aspect of the present invention, the step of introducing the fruit into a wash bath further comprises rolling the fruit to a location above an infeed end of the bath, stopping the travel of the fruit above the infeed end of the bath and pushing the fruit with the conveyor belt into a submerged passageway.

In accordance with still another aspect of the present invention, the step of stopping the travel of the fruit above the infeed end of the bath further comprises the step of rolling the fruit into a swinging barrier.

The present invention also provides an apparatus for sterilizing articles such as fresh fruit. The apparatus has a tank with an infeed end and an outfeed end. The tank is capable of holding a wash bath. A conveyor is located inside of the tank and traverses from the infeed end to the outfeed end. The conveyor has transverse members extending therefrom. A perforated ceiling is located above the conveyor and is immersed in the wash bath. The ceiling cooperates with the conveyor to maintain the articles submerged in the bath between the infeed and the outfeed ends.

In accordance with another aspect of the present invention, the perforated ceiling comprises parallel spaced apart rods.

In accordance with still another aspect of the present invention, the rods are top rods. There are also side rods spaced apart from one another and being located on each side of the conveyor between the infeed and outfeed ends.

In accordance with still another aspect of the present invention, there is a grate on each side of the conveyor. The grate is used to catch large debris to prevent this debris from interfering with the operation of the conveyor belt.

In accordance with still another aspect of the present invention, the transverse members extending from the conveyor comprise spaced apart fingers.

In accordance with still another aspect of the present invention, the fingers are chevron shaped.

In accordance with still another aspect of the present invention, the apparatus further comprises a second conveyor located at the outfeed end of the tank and extending to another location. Rotating brushes are in contact with the second conveyor. The brushes clean the second conveyor.

In accordance with still another aspect of the present invention, the brushes are located beneath the second conveyor.

In accordance with still another aspect of the present invention, the conveyor belt comprises a mesh and the transverse members comprise spaced apart fingers coupled to a plate. The plate is coupled to the mesh.

In accordance with still another aspect of the present invention, the apparatus further comprises a slotted ramp extending to a location above the infeed end of the conveyor. A swinging barrier is located above the ramp. The slots in the ramp are aligned with the transverse members of the conveyor belt so as to allow the transverse members to pass through the slots.

In accordance with still another aspect of the present invention, the apparatus further comprises a second conveyor located at the outfeed end of the tank and extending to another location. A motor moves the second conveyor belt. A sensor is located at the other location of the second conveyor belt. The sensor is connected to the motor, wherein when the sensor detects one of the articles of the second conveyor belt at the other location, the motor is stopped.

### BRIEF DESCRIPTION OF THE DRAWINGS

FIG. 1 is a schematic cross-sectional elevational view of the apparatus of the present invention, in accordance with a preferred embodiment.

FIG. 2 is a schematic top view of the apparatus of FIG. 1.

FIG. 3 is an elevational view of the conveyor belt and the cage with the cage partially broken away.

FIG. 3a is a detail view of the attachment of the fingers to the belt.

FIG. 4 is a cross-sectional view taken through lines IV-IV of FIG. 3.

FIG. 5 is a side view of a belt washing apparatus.

FIG. 6 is a view of the apparatus of FIG. 5, taken through lines VI-VI.

FIG. 7 is a perspective view of a finger assembly, in accordance with another embodiment.

FIG. 8 is an elevational view of the infeed end of the conveyor belt, in accordance with another embodiment.

FIG. 9 is a perspective view of the apparatus of FIG. 8, taken from the left end of FIG. 8, looking back to the infeed end of the conveyor.

FIG. 10 is a plan view of the conveyor belt and belt edge hold down arrangement of FIG. 10.

FIG. 11 is a cross-sectional view of a belt guide taken through lines XI-XI of FIG. 10.

FIG. 12 is a schematic view of the out feed conveyor and control system.

### DESCRIPTION OF THE PREFERRED EMBODIMENT

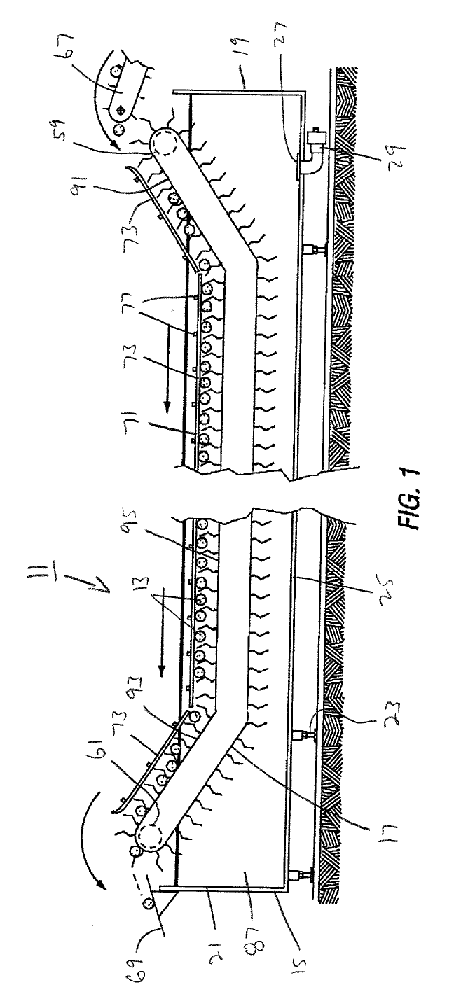

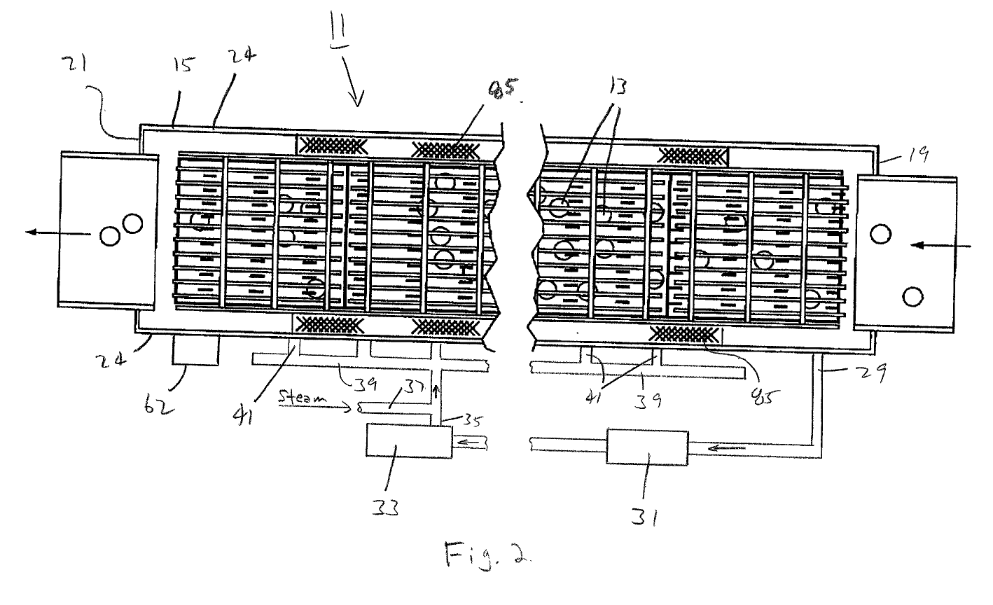

FIGS. 1 and 2 show the apparatus 11 of the present invention in accordance with a preferred embodiment. The apparatus 11 provides an elongated wash bath 87. A conveyor system moves fruit 13 through the bath, wherein the fruit is washed and the outer layer of the fruit is sterilized. The wash bath 87 is made up of hot water. Preferably, the water is 212° F. in order to sterilize the fruit. The fruit is moved through the wash bath in a continuous stream. This permits a large quantity of fruit to be processed in relatively short periods of time.

Mature fruit floats when put into water. A well known example of this is the game of bobbing for apples. In this game, apples are placed into a tub full of water. The apples float on the surface. A contestant attempts to grab an apple with his or her teeth. This is not an easy task because the fruit is easily pushed down into the water and just as easily, bobs back up to the surface. Conversely, when fruit becomes overripe, it sinks.

Conveying ripe fruit 13 through the wash bath 87 is a challenge because of the fruit's positive buoyancy. The fruit should have all of its surfaces in contact with the wash bath for the predetermined duration of time in order to ensure that the entire skin of the fruit is sterilized. If a piece of fruit floats in the wash bath, then a portion of its skin breaks the surface of the wash bath and consequently is not exposed to the washing and sterilizing action of the bath. This results in at least a portion of the fruit remaining unsterilized.

The present invention solves the problem of washing and sterilizing large quantities of floating fruit. The fruit is conveyed through the wash bath in a submerged condition. Submerging the fruit exposes the entire outer surface of the fruit to the wash bath for the proper predetermined duration of time, thereby assuring that the fruit becomes sterilized. The present invention provides a barrier or ceiling above the fruit so as to prevent the fruit from rising to the surface. In addition, the present invention moves the fruit along in a wash bath, wherein a stream of fruit can be washed.

The specifics of the apparatus 11 will now be described. The apparatus 11 includes a wash tank 15 and a conveyor system 17.

Still referring to FIGS. 1 and 2, the wash tank 15 and its associated plumbing for circulating water is conventional and commercially available. Such tanks are used as chillers for food products such as meat and poultry. The conveyor system 17 is not conventional.

The wash tank 15 is generally elongated and has an infeed end 19 and an outfeed end 21. The tank is capable of containing a quantity of water therein. The tank is supported up off of the floor by legs 23. The tank has side walls 24 and a bottom wall 25 that extends between the infeed and outfeed ends 19, 21. The bottom wall 25 of the tank is sloped downwardly from the outfeed end toward the infeed end, where drain openings 27 are located at the lowest places.

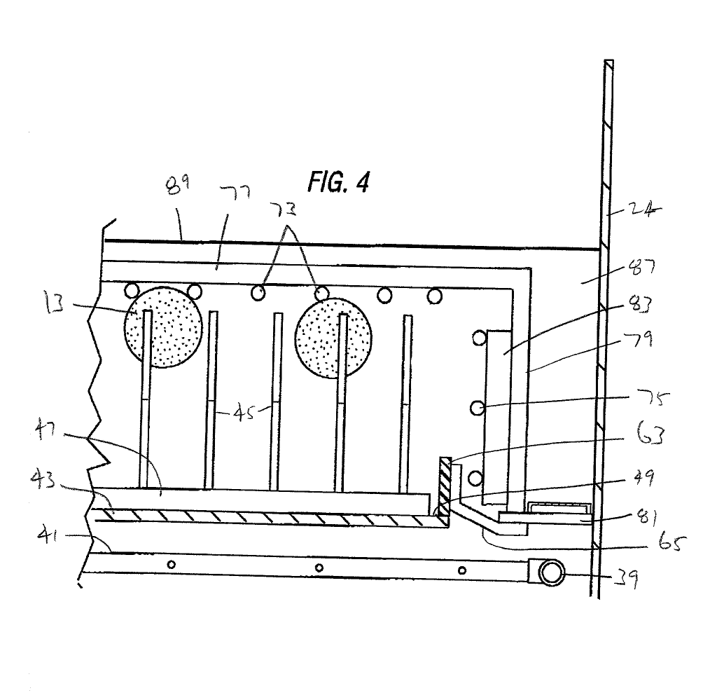

As shown in FIG. 2, the plumbing system includes drain pipes 29 connected to the drain openings 27 (FIG. 1). The drain pipes 29 are connected to filters 31, which in turn are connected to the input of a pump 33. Extending from the pump output is an outlet pipe 35. A steam injection pipe 37 is coupled to the outlet pipe. The outlet pipe 35 is also coupled to two manifolds 39. One manifold 39 is located outside of the tank 15 (see FIG. 2). Branch pipes 41 extend from the manifold, through the wall of the tank and extend across the bottom width of the tank. The other manifold 39 is located inside of the tank 15 (see FIG. 4) and extends along the side. Branch pipes 41 extend from this other manifold and extend across the width of the tank. These other branch pipes 41 are located about mid-depth in the tank. All of the branch pipes 41 are perforated so that water is injected into the tank. In the preferred embodiment, there is redundancy in the drain pipes 29, filters 31 and pumps 33. Connecting valves allow the use of one or both of the pumps. The steam injection pipe 37 is connected to the outlet of a boiler (not shown), which provides the steam.

There is also provided a make up water system (not shown). The tank 15 has a float therein. When the water level in the tank drops below a predetermined level, the float drops and opens a valve. Water from an inlet pipe located near the infeed end fills the tank to the predetermined level. When the water reaches the predetermined level, the float closes the valve and shuts off the water flow into the tank. The water that is introduced from the inlet pipe need not be hot and can be cold. Because steam is injected into the tank by way of the pipe 37, very little make up water needs to be added.

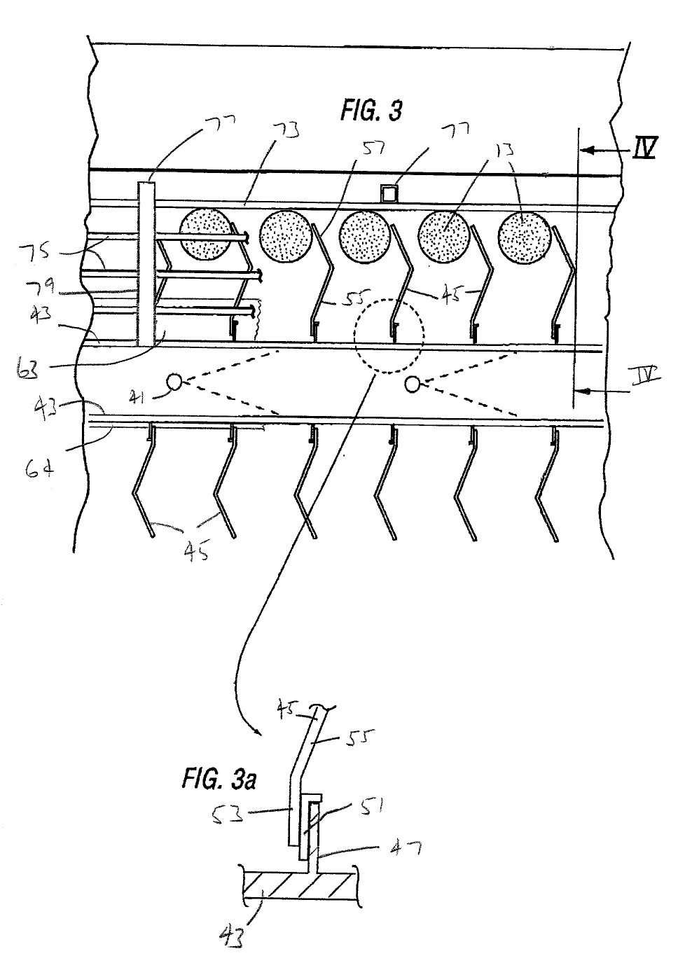

The conveyor system 17 will now be described. Referring to FIGS. 3 and 4, the conveyor system 17 includes a conveyor belt 43 and supporting structure for the belt. The conveyor belt 43 is made up of a plurality of links that are pivotally coupled together. The links are coupled together with pins that extend transverse to the direction of travel. The links can be plastic or metal. The links are of the plastic open top style, which links are conventional and commercially available.

The conveyor belt 43 has, at periodic intervals, links with fingers 45, which fingers extend from the links. The fingers 45 extend generally out from the conveyor belt 43 in rows. The fingers 45 are used to push the floating fruit along in the wash bath. When fruit is located between two rows of fingers, the upstream fingers push the fruit downstream.

In the preferred embodiment, the fingers 45 are coupled to the conveyor belt links by way of flighting 47 (see FIG. 3a). Those links that are equipped with the fingers 45 have integral flighting 47 extending transversely therefrom. The flighting 47 extends across most of the width of the conveyor belt, leaving a short section 49 (see FIG. 4) of each end of the belt link without the flighting. The fingers 45 are welded to a metal plate 51. The plate is in turn coupled to the flighting (for example by bolts). Plural fingers 45 are coupled to each length of flighting. In the preferred embodiment, the fingers are spaced several inches apart.

The fingers 45, which are metal strips, are shaped like the bars of a chevron when viewed from the side, as shown in FIG. 3. Rows containing the bars are spaced apart from each other so as to provide room for receiving the fruit. Each finger 45 has a mounting portion 53 (FIG. 3a) that couples to the mounting plate 51. The mounting portion 53 of each finger 45 overlies the mounting plate 51 so that the mounting plate is interposed between the finger mounting portions and the flighting 47 of the conveyor belt. Extending from the mounting portion 53 of each finger is an inner portion 55. Extending from the free end of each inner portion is an outer portion 57. Both the inner and outer portions 55, 57 are angled with respect to a plane formed by the conveyor belt. In the preferred embodiment, the angle between the inner and outer portions is about 120° and the inner portion 55 is shorter than the outer portion 57. The inner portion 55 is angled upstream while the outer portion 57 is angled downstream.

As shown in FIG. 1, the conveyor belt traverses a path between the infeed and the outfeed ends 19, 21. At the infeed end 19, the conveyor belt rounds a set of sprockets 59 located above the water level in the tank. From there, the belt descends down into the wash bath 87 and then toward the outfeed end 21. Near the outfeed end, the belt ascends out of the wash bath where it rounds another set of sprockets 61 located above the water level of the tank. The conveyor belt has a descending portion 91 (from the sprockets 59 down into the bath 87), an ascending portion 93 (from the sprockets 61 down into the bath) and a horizontal portion 95 (between the descending and ascending portions 91, 93).

The belt is driven by the sprockets 61 at the outfeed end 21. A motor 62 (see FIG. 2) rotates the sprockets. The sprockets 59 at the infeed end are idler sprockets.

In the horizontal portion 95, the conveyor belt traverses a flat or horizontal path. There is an upper section of the horizontal portion 95, which moves the fruit from the infeed end 19 to the outfeed end 21, and a lower section of the horizontal portion, which returns toward the infeed end. The upper section of the horizontal portion of the conveyor belt is held down by the side plates 63 (see FIG. 4). The side plates, which are made of plastic, extend along the length of the upper section of the horizontal portion 95 and are coupled to the wash tank 15 by way of tabs 65. The side plates 63 have bottom edges that bear on the top surface belt ends 49 of the conveyor belt 43. The lower section of the horizontal portion of the conveyor belt bears on support surfaces. Specifically, the ends 49 of the belt slide along a support shelf 64 (see FIG. 3) that is mounted to the bottom of the tank. The belt 26 has a tensioning sprocket located below the sprockets 61.

At the infeed end 19 of the wash tank 15, the conveyor belt cooperates with an infeed conveyor 67. The infeed conveyor 67 drops fruit onto the conveyor belt. At the outfeed end 21 of the wash tank, the conveyor belt cooperates with an outfeed conveyor 69 or ramp. The fruit is passed from the conveyor belt to the outfeed conveyor 69.

As shown in FIG. 4, some of the branch pipes 41 are located between the upper and lower sections of the horizontal portion 95 of the conveyor belt. This allows hot water to be injected under the fruit, along the length of the tank. A counterflow is created with the drain openings being located at the infeed end of the wash tank. Thus, the water flows in the opposite direction of the fruit.

The upper section of the conveyor belt is provided with a cage 71 (see FIGS. 3 and 4) to keep the fruit that is being conveyed in a submerged condition. The cage 71 provides a barrier on the top and sides of the upper section of the conveyor belt. (In FIG. 1, only the top 73, 77 of the cage 71 is shown for clarity.)

The cage 71 is made up of top rods 73 and side rods 75 spaced apart from one another. The top and side rods 73, 75 extend parallel to the direction of travel of the conveyor belt 43. The top and side rods are spaced apart a distance that is smaller than the side of the fruit, so as to prevent the escape of fruit therethrough and to prevent the wedging of fruit. The top and side rods 73, 75 are coupled together with transverse bars 77, 79. Specifically, the top rods 73 are welded to transverse bars 77, which extend across the top of the top rods. Depending down from each end of the transverse bars is a leg 79. Each of the legs 79 bears on the support plate 81 that is positioned at the side wall 24 of the tank at about the same level as the upper section of the conveyor belt. The support plates 81 extend along the length of the tank. The top rods 73 are located above the upper ends of the fingers 45. The side rods 75 are mounted to the legs by mounting plates 83.

The top and side rods 73, 75 extend along most of the length of the upper section of the conveyor. At the descending and ascending portions 91, 93, the rods extend up out of the water. The ends of the top rods 73 are flared up.

A grate 85 is positioned on each support plate 81. Thus, there is a grate 85 along each side of the upper portion of the conveyor belt. The grates 85 capture large pieces of debris that circulate in the wash bath. Smaller debris, such as sand and dirt, flows along the bottom wall of the tank, where it is removed at the drains 27. The filters 31 capture the smaller debris. The filters are cleaned periodically.

The washing process will now be described. The fruit 13 is loaded into the wash tank 15 by way of the infeed conveyor 67. The infeed conveyor 67 is positioned so as to place or drop the fruit onto the fingers 45, just as the fingers are rounding the sprockets 59. This avoids damage to the fruit by avoiding dropping the fruit onto the conveyor belt. The fingers are resilient and consequently are softer to the fruit, thereby minimizing damage.

As the fingers 45 round the sprockets 59 to the top side of the conveyor, the fruit rolls down to bear on the conveyor belt. The fruit enters the cage 71 as the belt traverses down the descending portion 91 to put the fruit into the wash bath 87.

The wash bath 87 is, in the preferred embodiment, hot water. The temperature is about 190°, with a dwell time (the amount of time the fruit is in the wash bath) of 3-4 minutes. Various additives can be provided to the wash bath, such as sterilizing agents (for example, chlorine, ozone), surfactants and/or organic acid (such as citric acid and malic acid).

The level 89 of the wash bath 87 is above the top rods 73 of the cage. Thus, the top rods are submerged.

As the fruit enters the water, it tends to float. However, the top rods 73 of the cage 71 prevent the fruit from reaching the surface 89. Consequently, the entire skin of each piece of fruit remain submerged and exposed to the wash bath. The speed of the conveyor and the length of the wash tank, and specifically the horizontal portion 95 of the conveyor belt, determine the dwell time of the fruit in the wash bath.

The fingers 45 push the fruit 13 along. The top bars 73 offer little or no resistance to the fruit moving along to the outfeed end. The rods are smooth and do not snag the fruit.

The side rods 75 keep the fruit aligned with the fingers so that the fruit can be pushed along. In addition, the side rods prevent the fruit from exiting the conveyor system, which exiting floating fruit could get jammed or otherwise damage the system.

When the fruit reaches the ascending portion 93, it is brought out of the bath, wherein the fruit bears on the conveyor belt. In many instances, several pieces of fruit will be stacked up together in a single row. This stacked mass of fruit pushes on the fingers 45, which in turn yield by resiliently bending. The chevron shape of the fingers provide that the outer portions 57 of the fingers are substantially vertical, even when bent back from the weight of the fruit. Thus, the fingers 45 are designed to bend and still convey the fruit up out of the wash bath.

The fruit is then put on to the outfeed conveyor 69.

The dwell time of the fruit depends on several factors, such as the temperature of the water bath, the thickness of the skin and the type of fruit. In general, the fruit should be submerged a sufficient period of time so that the bacteria on the skin is killed, yet the flesh of the fruit inside of the skin is unaltered or unaffected by the heat. This particular process works very well for melons such as watermelon, cantaloupe and honeydew. However, other kinds of fruit can be processed using the invention. In the preferred embodiment, the fruit is chilled before being washed in the wash bath. Chilling the fruit serves to minimize heat damage to the fruit and maintains the flesh at a cool temperature for longer shelf life. The temperature of the fruit, as it is loaded into the apparatus, can be between 33° Fahrenheit (above freezing) up to room temperature. The temperature of the wash bath is preferably 190° or higher (even steam can be used). With lower temperatures, longer dwell times must be used to obtain sterilization.

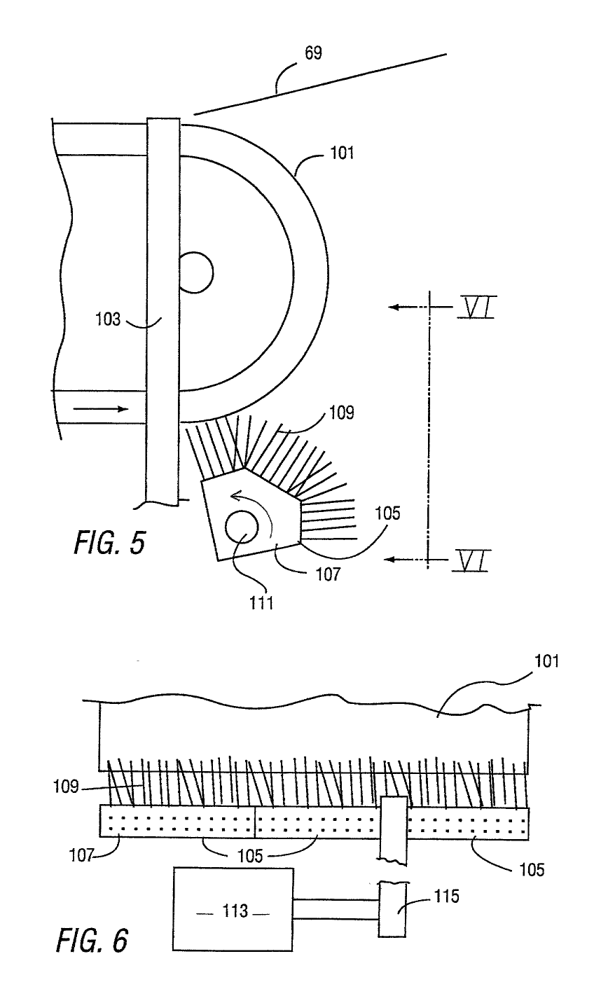

FIGS. 5 and 6 illustrate an apparatus for washing a conveyor belt 101. The conveyor belt 101 is located below the outfeed belt or ramp 69. Fruit exiting the washer moves down the ramp 69 and lands on the conveyor belt 101. The conveyor belt 101 conveys the fruit to another location. The belt 101 is supported up off of the floor by legs 103. The belt rounds sprockets (not shown), which sprockets rotate about an axle that in turn is rotatably mounted to the legs 103 by way of bearings. In the view shown in FIG. 5, the belt 101 moves counterclockwise.

The underside of the belt 101 is cleaned by rotating brushes 105. The brushes 105, which have bristles 109 extending out from a body 107, are mounted to a shaft 111. Set screws couple the brush bodies 107 to the shaft 111. Plural brushes 105 can be mounted to the shaft 111. The shaft is mounted to the legs by way of bearings. The shaft is coupled to an electric motor 113 by way of sheaves and a belt 115.

As the conveyor belt 101 moves, the motor 113 rotates the shaft 111 and thus rotates the brushes 105. The brushes 105 brush against the outer surfaces of the conveyor belt 101, thus cleaning the belt. Water can be sprayed or otherwise applied to enhance the cleaning process. The brushes 105 rotate opposite to the surface of the belt being cleaned. Thus, in FIG. 5, the brushes rotate counterclockwise.

In the preferred embodiment, the brushes 105 are noncircular. The brushes can however be circular.

The apparatus shown in FIGS. 5 and 6 cleans the conveyor belt 101 to ensure sanitary conditions. Such sanitation is important when working with food. The conveyor belt 43 that is located in the wash tank 15 is cleaned by the wash bath 87 each time the belt is submerged.

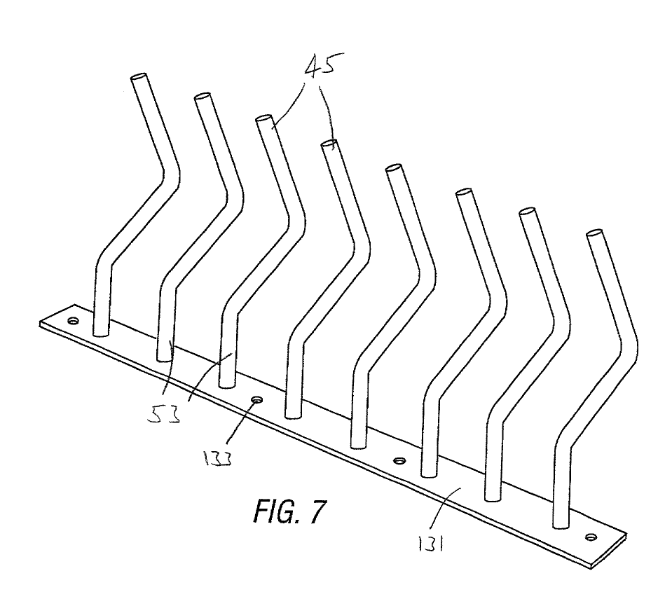

FIGS. 7-12 illustrate the apparatus in accordance with another embodiment.

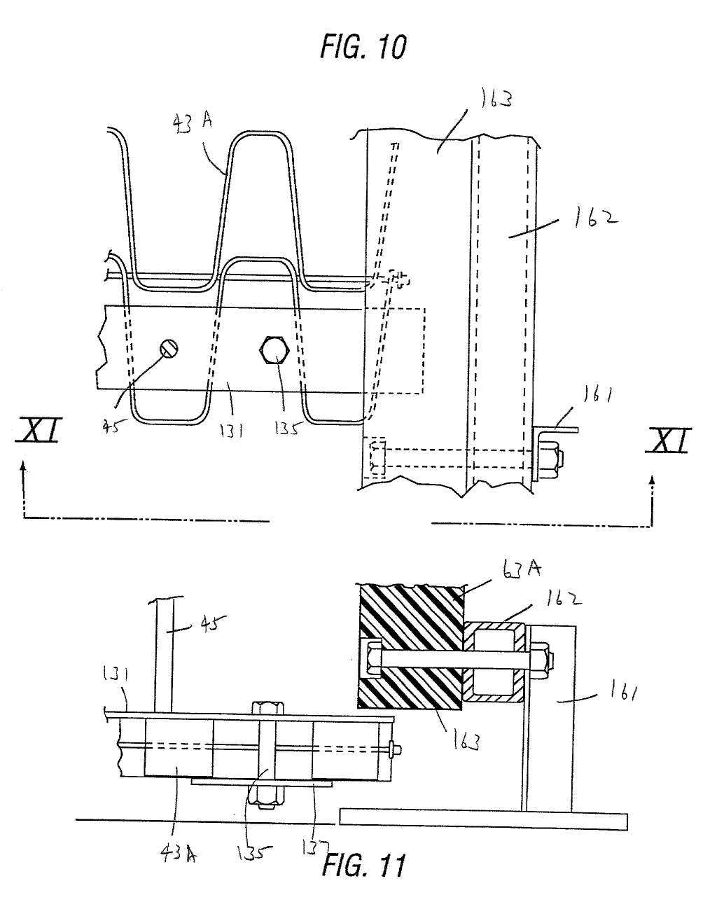

In FIGS. 7, 10 and 11, another coupling arrangement for the fingers 45 is shown. The conveyor belt 43A (see FIGS. 10 and 11) is a metal mesh. It has been found that a metal mesh belt is more durable than a plastic belt. The metal mesh belt 43A is conventional and commercially available and has no flighting thereon.

The fingers 45 extend outwardly from one side of a metal plate 131 or strip. The mounting portion 53 of the fingers 45 are welded to the plate 131 such that the plate is perpendicular to the mounting portions 53. The other side of the plate 131 is located on the conveyor belt. The plate 131 extends from one edge of the conveyor belt 43A to the opposite edge. Thus, the plate 131 is oriented transverse to the direction that the belt 43A travels. The plate 131 has bolt holes 133, which receive bolts 135 for securing the plate to the conveyor belt. Washers 137 are provided on the underside of the belt 43A; the bolts thus clamp the plate 131 to the belt.

The finger arrangement shown in FIG. 7, 10 and 11 provides a much stronger mechanism for pushing the fruit through the wash bath. The fingers are securely coupled to the belt 43A such that the mechanical stresses are distributed across a relatively large portion of the belt 43A. Consequently, the belt and finger arrangement are more durable with a reduction in down time.

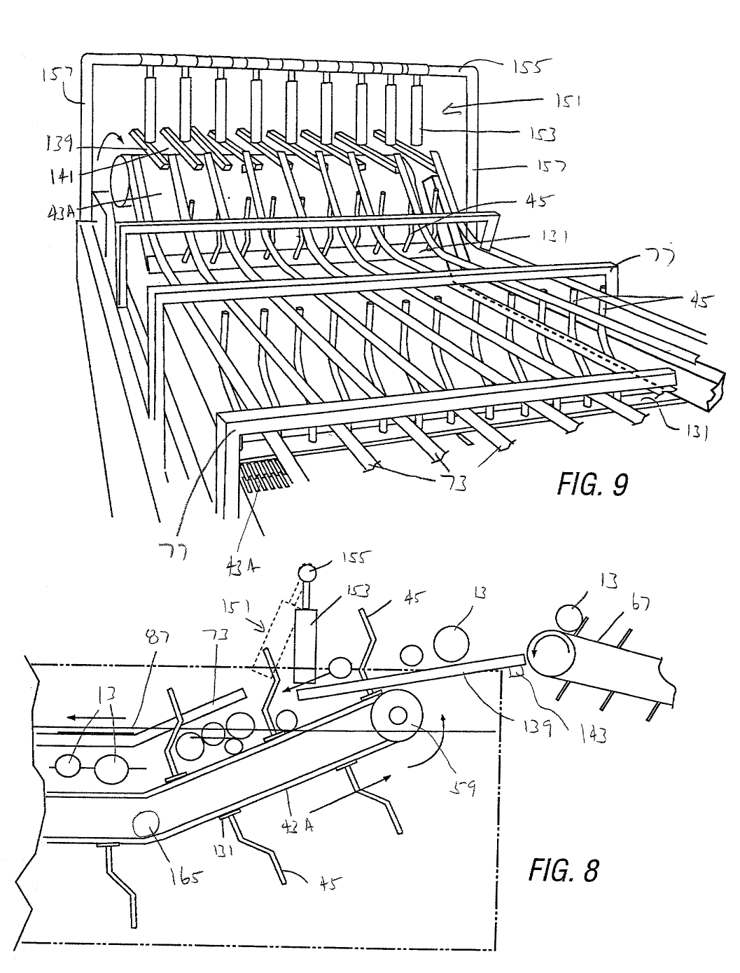

The infeed end of the conveyor belt 43A is shown in accordance with another embodiment in FIGS. 8 and 9. The infeed end controls the descent of the fruit into the wash bath so as to minimize stresses on the fingers and the conveyor belt.

The infeed conveyor 67 drops the fruit 13 onto a ramp 139 that is located above and before the infeed end of the conveyor belt 43A. The ramp 139 is inclined slightly downward from the infeed conveyor 67 toward the wash bath 87. The downstream end of the ramp 139 need not be submerged in the wash bath and can be above the bath level, as shown in FIG. 8. The ramp 139 overlies a portion of the infeed end of the conveyor 43A.

The ramp 139 has slots 141, which slots receive the fingers 45 of the conveyor belts. In the preferred embodiment, the ramp 139 is formed of square tubes spaced apart from each other so as to form the slots 141. A transverse tube 143 couples the ramp tubes together. The transverse tube 143 is located near the infeed conveyor 67. The ramp tubes are parallel to each other.

A swinging barrier or baffle 151 is located above the downstream end of the ramp 139. The swinging barrier 151 has a number of vertically oriented members 153, closely spaced across the width of the ramp 139. The members 153 depend from a support 155 that is located above the ramp 139 (see FIG. 9). The support 155 has legs 157 that bear on the wash tank. The individual members 153 pivot about the support 155 in the direction of travel of the conveyor belt 43A. The members 153 are finger-like and are weighted so as to increase their mass.

The ramp 139 and members 153 act together to control the dropping of the fruit into the wash bath 87. The fruit is dropped by the infeed conveyor 67 onto the upstream end of the ramp 139. Gravity then causes the fruit to roll or slide along the ramp 139 toward the downstream end. Preferably, the inclination of the ramp is relatively shallow (5-30 degrees in the preferred embodiment) in order to minimize the velocity of the fruit in rolling down the ramp. At the downstream end of the ramp, the progress of the fruit is halted because the fruit hits the members 153. The members preferably have sufficient mass to stop the fruit from rolling past the barrier. The fruit then stays on the ramp until pushed through the barrier by the conveyor belt fingers 45. As shown in FIG. 8, the fingers 45 round the infeed sprockets 59 and extend up through the ramp 139. As the fingers 45 advance toward the barrier 151, the fingers contact the fruit that is stopped at the barrier, wherein the fingers push the fruit through the respective swinging members 153. The members 153 swing up and out of the way, allowing the fruit to roll off of the downstream end of the ramp 139 and into the wash bath 87. The fingers then push the fruit into the upstream end of the cage, wherein the fruit becomes submerged in the wash bath. The infeed end of the cage (the top 73 is shown in FIGS. 8 and 9) is inclined up to receive the fruit. The fingers 45 continue to push the fruit all the way through the cage and the wash bath. The outfeed end of the conveyor belt is as described above with respect to FIGS. 1 and 2.

FIGS. 10 and 11 illustrate a hold down arrangement for the conveyor belt 43A. As shown in FIG. 1, the conveyor belt has a descending portion 91, a horizontal portion 95 and an ascending portion 93. The descending and ascending portions 91, 93 are inclined.

The side plates 63A are provided on each side or edge of the upper section of the conveyor belt. The side plates 63A extend between an inclined portion to the horizontal portion. Thus, there are two pairs of side plates. One pair extends along the two edges of the conveyor belt for most of the descending portion and along the adjacent horizontal portion. The other pair extends along the two edges of the conveyor belt from the horizontal portion along the ascending portion.

The side plates 63A are made of plastic and are bolted to supports 161. (In the preferred embodiment, standoff bars 162 are used between the side plates 63A and the supports 161.) The bottom edges 163 of the side plates are flat. The upper edges of the conveyor belt 43A and the plates 131, bear along the bottom edges 163 of the side plates. The side plates 63A force the upper section of the conveyor belt 43A to follow the path of the descending portion into the wash bath 87, and then proceeding horizontally and then ascending out of the wash bath. The lower section of the conveyor belt is guided by idler wheels 165 or sprockets (see FIG. 8).

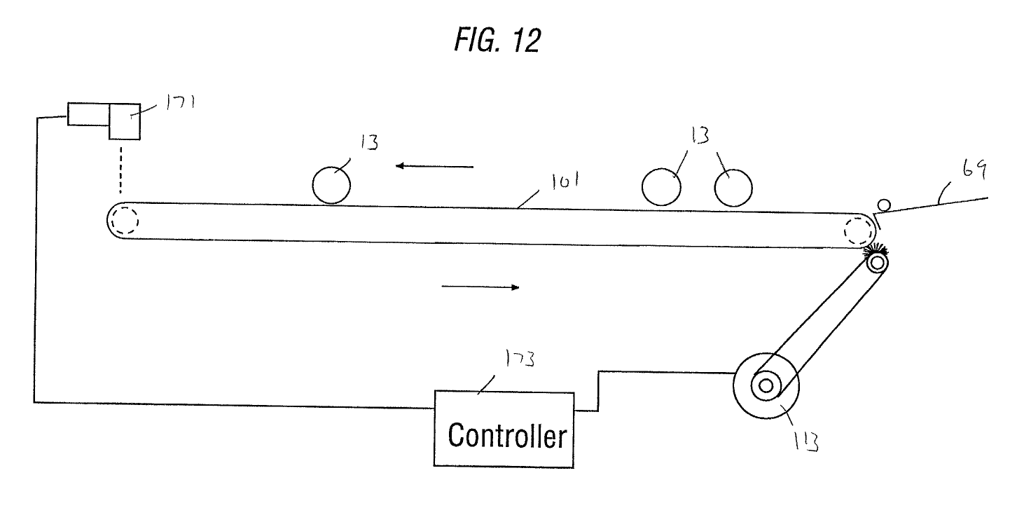

The outfeed conveyor 101 is shown in FIG. 12. After the fruit is washed and sterilized, it exits the wash tank and is conveyed to the outfeed conveyor 101. The outfeed conveyor 101 is horizontal. Personnel pluck the clean fruit 13 off of the outfeed conveyor for further processing. Because the fruit is sanitized, care must be taken to keep the fruit sanitized. Consequently, if fruit reaches the end of the outfeed conveyor, the fruit could be dumped to the floor.

As shown in FIG. 12, a photoelectric sensor 171 is located at the downstream end of the conveyor 101. The photoelectric sensor is connected to an input of a controller 173. The controller 173 has an output that is connected to the motor 113 that drives the outfeed conveyor 101. The controller 173 can be a relay.

The motor 113 moves the outfeed conveyor 101 and any fruit located thereon. Typically, personnel will remove all of the fruit from the outfeed conveyor before the fruit reaches the sensor 171. However, if the sensor 171 detects fruit at the end of the outfeed conveyor 101, the controller 173 turns the motor 113 off. This stops the movement of the outfeed conveyor 101. The motor 113 stays off until the fruit is moved from the sensor's field, wherein the motor restarts and moves the outfeed conveyor once again. Thus, when fruit reaches the end of the outfeed conveyor, the conveyor stops to preserve the sanitary condition of the fruit.

The foregoing disclosure and the showings made in the drawings are merely illustrative of the principles of this invention and are not to be interpreted in a limiting sense.

1. A method for sterilizing fresh fruit, comprising the steps of:
a) introducing the fruit into a wash bath;
b) conveying the fruit through the bath;
c) while the fruit is being conveyed in the bath, maintaining the fruit in a submerged condition in the bath;
d) removing the fruit from the bath.

2. The method of claim 1 wherein the fruit comprises melons.

3. The method of claim 1 wherein the step of conveying the fruit through the bath further comprises the step of pushing the fruit with a conveyor belt.

4. The method of claim 3 wherein the step of pushing the fruit with a conveyor belt further comprises the steps of:
a) locating the conveyor belt beneath the fruit;
b) using extensions from the conveyor belt to contact the fruit.

5. The method of claim 1 wherein the step of maintaining the fruit in a submerged condition in the bath further comprises the step of providing a ceiling that is below a level of the bath, the fruit being conveyed beneath the ceiling.

6. The method of claim 5 further comprising the step of maintaining the level of the bath at a constant level.

7. The method of claim 1 wherein the step of maintaining the fruit in a submerged condition in the bath further comprises the step of conveying the fruit through a submerged passageway.

8. The method of claim 1, wherein:
a) the step of conveying the fruit through the bath further comprises the step of pushing the fruit with a conveyor belt;
b) the step of maintaining the fruit in a submerged condition in the bath further comprises the step of conveying the fruit through a submerged passageway;
c) maintaining the level of the bath at a constant level.

9. The method of claim 1 further comprising the step of chilling the fruit to a temperature that is lower than room temperature before introducing the fruit into the wash bath.

10. The method of claim 1 wherein the step of introducing the fruit into a wash bath further comprises the steps of:
a) rolling the fruit to a location above an infeed end of the bath;
b) stopping the travel of the fruit above the infeed end of the bath;
c) pushing the fruit with a conveyor belt into a submerged passageway.

11. The method of claim 10 wherein the step of stopping the travel of the fruit above the infeed end of the bath further comprises the step of rolling the fruit into a swinging barrier.

12. An apparatus for sterilizing articles such as fresh fruit, comprising:
a) a tank having an infeed end and an outfeed end, the tank being capable of holding a wash bath;
b) a conveyor located inside of the tank and traversing from the infeed end to the outfeed end, the conveyor having transverse members extending therefrom;
c) a perforated ceiling located above the conveyor and immersed in the wash bath, the ceiling cooperating with the conveyor to maintain the articles submerged in the bath between the infeed and outfeed ends.

13. The apparatus of claim 12 wherein the perforated ceiling comprises parallel spaced apart rods.

14. The apparatus of claim 13 wherein the rods are top rods, further comprising side rods that are spaced apart from one another and are located on each side of the conveyor between the infeed and outfeed ends.

15. The apparatus of claim 12 further comprising a grate on each side of the conveyor.

16. The apparatus of claim 12 wherein the transverse members extending from the conveyor comprise spaced apart fingers.

17. The apparatus of claim 16 wherein the fingers are chevron shaped.

18. The apparatus of claim 12 further comprising:
a) a second conveyor located at the outfeed end of the tank and extending to another location;
b) rotating brushes in contact with the second conveyor, the brushes cleaning the second conveyor.

19. The apparatus of claim 18 wherein the brushes are located beneath the second conveyor.

20. The apparatus of claim 12 wherein the conveyor belt comprises a mesh and the transverse members comprise spaced apart fingers coupled to a plate, the plate being coupled to the mesh.

21. The apparatus of claim 12, further comprising:
a) a slotted ramp extending to a location above the infeed end of the conveyor;
b) a swinging barrier located above the ramp;
c) the slots in the ramp being aligned with the transverse members of the conveyor so as to allow the transverse members to pass through the slots.

22. The apparatus of claim 12, further comprising:
a) a second conveyor located at the outfeed end of the tank and extending to another location;
b) a motor for moving the second conveyor belt;
c) a sensor located at the other location, the sensor being connected with the motor, wherein when the sensor detects one of the articles on the second conveyor belt at the other location, the motor is stopped.
